(19) United States
(12) Patent Application Publication
(10) Pub. No.: US 2017/0371120 A1
(43) Pub. Date: Dec. 28, 2017

(54) WALL-MOUNTABLE OPTICAL FIBER DISTRIBUTION TERMINAL ASSEMBLY

(71) Applicant: AFL TELECOMMUNICATIONS LLC, Duncan, SC (US)

(72) Inventors: Edward MORRIS, Greer, SC (US); Roger VAUGHN, Greer, SC (US)

(21) Appl. No.: 15/542,579

(22) PCT Filed: Jan. 15, 2016
(86) PCT No.: PCT/US2016/013612

§ 371 Date: Jul. 10, 2017

Related U.S. Application Data
(60) Provisional application No. 62/103,667, filed on Jan. 15, 2015.

(51) Int. Cl. G02B 6/44; B65H 75/44

(52) U.S. Cl. CPC G02B 6/4457; B65H 75/4476; B65H 75/446; G02B 6/4466; B65H 2701/32

(57) ABSTRACT

An optical fiber distribution terminal assembly comprises a housing having a rear housing portion and a front housing portion moveable between an open position and a closed position defining an interior. The housing further defines at least one port for passage of a optical fiber distribution cable. A rotatable reel is located in the interior of the housing, the reel carrying a length of optical fiber distribution cable. A distribution module, also located in the housing, is operative to distribute source fibers of the optical fiber distribution cable to individual subscriber cables.

### BACKGROUND OF THE INVENTION

The present invention relates generally to fiber optic cable. More particularly, the present invention relates to a wall-mountable optical fiber distribution terminal at which connection can be made from a multiple-fiber-distribution cable to service connections for individual subscribers.

The ability of high-quality optical fiber to transmit large amounts of information without appreciable signal degradation is well known. As a result, optical fibers have found widespread use in many applications, such as voice and data transmission. For example, the need for greater bandwidth in residential settings has brought optical fibers directly into homes and multiple dwelling units (MDUs). Such applications have generally come to be known by the acronym FTTP (Fiber To The Premises).

In the case of an MDU, for example, a single multi-fiber cable can supply service to a particular floor of the building. Toward this end, the multi-fiber cable may extend into the housing of a wall-mounted distribution terminal assembly. Fibers extending into the dwelling units are selectively connectable to the multi-fiber cable inside the housing to provide service to (or disconnect service from) a particular subscriber. Typically, the interior of the housing is accessible only by a technician employed by the telecommunications company providing the service.

Current wall-mountable distribution terminals, also referred to as a wall-mount enclosure (WME), require a separate reel of cable and wall mount enclosure. Once cable is deployed, remaining cable is removed from the reel and stored in the WME. This method of deployment is relatively labor intensive.

The present invention recognizes the foregoing considerations, and others, of the prior art.

### SUMMARY OF THE INVENTION

According to one aspect, the present invention provides an optical fiber distribution terminal assembly comprising a housing having a first housing portion and a second housing portion moveable between an open position and a closed position defining an interior. The housing further defines at least one port for passage of an optical fiber distribution cable. A reel is located in the interior of the housing, the reel carrying a length of optical fiber distribution cable. A distribution module, also located in the housing, is operative to distribute service from the optical fiber distribution cable to individual subscriber cables.

In accordance with an exemplary embodiment, the reel is configured to be maintained in a particular angular position when the second housing portion is in the closed position. For example, the reel may have a series of positioning slots spaced apart about its periphery. The second housing portion may likewise carry a protrusion that engages one of the positioning slots when the second housing portion is in the closed position.

Preferably, one end of the optical fiber distribution cable may be terminated with at least one fiber optic connector for receipt in a corresponding socket of the distribution module. In this regard, the distribution module may further include a plurality of individual subscriber sockets. Toward this end, the second housing portion may further define a front compartment closable by a lid, with the individual subscriber sockets being accessible by opening the lid. In addition, the second housing portion may be secured to the first housing portion by fasteners accessible by opening the lid. The lid is preferably configured to be locked when closed.

Another aspect of the present invention provides an optical fiber distribution terminal assembly comprising a housing having a first housing portion and a second housing portion connectable together in a closed position so as to define an interior. The housing defines at least one port for passage of an optical fiber distribution cable. A rotatable reel, located in the interior of the housing, carries a length of optical fiber distribution cable. The reel is configured to be maintained in a particular angular position when the second housing portion is in the closed position. For example, the reel may have a series of positioning slots spaced apart about its periphery one of which may be engaged by a protrusion carried on the second housing portion when the housing is in the closed position.

Exemplary embodiments may further include a distribution module, located in the housing, which is operative to distribute service from the optical fiber distribution cable to individual subscriber cables. One end of the optical fiber distribution cable may be terminated with at least one fiber optic connector for receipt in a corresponding socket of the distribution module. Moreover, the second housing portion may further define a front compartment closable by a lid. In such embodiments, the distribution module may extend between the front compartment and the interior of the housing.

According to another aspect, the present invention provides a combination comprising a reel having a hub and a pair of side flanges. A length of fiber optic cable is wrapped around the hub of the reel, the fiber optic cable having a first end and a second end. The hub of the reel defines an aperture through which the first end of the fiber optic cable passes. The reel has a series of positioning slots spaced apart about a periphery of at least one of the flanges. For example, the reel may have positioning slots spaced apart about both of the flanges such that positioning slots on respective flanges are aligned with each other.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a perspective view of a wall-mountable optical fiber distribution terminal assembly in accordance with an embodiment of the present invention with the housing closed.

FIG. 2 is a perspective view showing the terminal assembly of FIG. 1 with the housing open to reveal internal structure.

FIG. 3 is a perspective view similar to FIG. 1 but with the lid open to show individual fiber connector adapters located therein.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

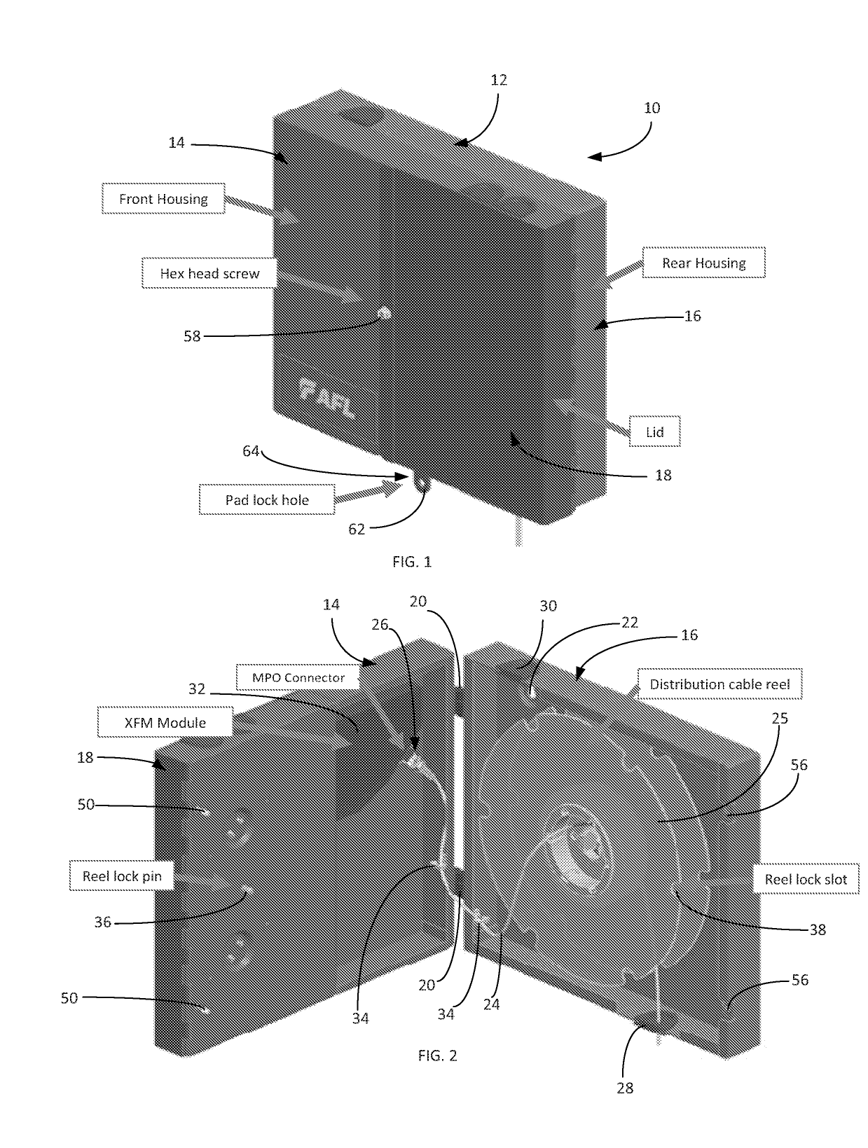

Referring first to FIG. 1, a wall-mountable terminal assembly 10 in accordance with a preferred embodiment of the present invention is illustrated. Terminal assembly 10 includes an enclosure 12 having two housing portions, i.e., a front housing 14 which is hinged to a rear housing 16. A lid 18 is hinged to front housing 14 to enclose a compartment defined by the front housing.

FIG. 2 shows front housing 14 in the open position with respect to rear housing 16. As can be seen, a pair of lift-off hinges 20 are used to connect the two housing portions together in this case. Lift-off hinges allow the front housing 14 to be totally removed from rear housing 16 which can facilitate mounting of rear housing 16 to a wall. In this regard, rear housing 16 may define a plurality of mounting apertures such as aperture 22. As is common, these apertures may have a teardrop shape with a larger lower portion for pass-through of a fastener head and a smaller upper portion that receives the fastener shank but does not allow the head to pass back through.

As shown in FIG. 2, a length of distribution cable 24 is located inside of the enclosure 12. Depending on the application, cable 24 can be supplied in different lengths on a reel 25 also located inside of enclosure 12. According to this embodiment, both ends of cable 24 are terminated with one or more suitable connectors, such as connector 26. In this case, connector 26 is configured as a “multi-fiber push-on” (“MPO”) connector. The end of cable 24 having connector 26 is routed through an aperture in the center hub of reel 25 as shown. The other end of cable 24 exits enclosure 12 through a grommet 28 located in a port at the bottom of rear housing 16. (A similar grommet 30 is located at the top of rear housing 16 so that the cable can exit there if necessary or desired in a particular installation.) In this regard, the desired length needed for installation is pulled off the reel, with the unused cable remaining on the reel after installation.

In this embodiment, a suitable distribution module 32 is mounted to front housing 14. The distribution module 32 separates the fibers of the multi-fiber cable to individual adapters corresponding to a respective subscriber's service cable. In this regard, the illustrated embodiment utilizes the type of module sold by AFL Telecommunications, the assignee of the present invention, under the trademark Xpress Fiber Management (XFM). After cable 24 is deployed, connector 26 is connected to an adaptor (socket) on module 32. The length of cable 24 between connector 26 and reel 25 may be maintained in place via suitable clips, such as clips 34. While an XFM-type module is shown in the illustrated embodiment, one skilled in the art will appreciate that any suitable type of distribution module or similar device can be used, such as a polimod, LGX plate, or similar fiber optic interface mounted in the enclosure 12. Also, while one distribution module is shown in the illustrated embodiment, it is contemplated that terminal assemblies in accordance with the present invention may be equipped with a greater number of distribution modules as necessary or desired. (Such embodiments might also have multiple reels 25 and other additional components to accommodate additional distribution cables.)

After connector 26 is attached to distribution module 32 (with excess slack wound around reel 25), front housing is moved into the closed position. In the preferred embodiment, one or more protrusions may be provided on the inside of front housing 14 to prevent subsequent rotation of reel 25. Such protrusion(s), for example, may take the form of a lock pin 36. In this regard, reel 25 defines a series of slots, such as slot 38, spaced apart about the periphery of at least one of the reel's flanges. For example, both flanges may have such slots, aligned with each other, as shown. Reel 25 is oriented by the technician so that one of these slots will align with lock pin 36 when front housing 14 is closed. The rotational hub of reel 25 may have detents that indicate certain positions in the rotation of reel 25 to assist the technician in getting the reel in the correct angular position for pin alignment. As can be seen in FIG. 2, rear housing 16 preferably has a depth slightly greater than the axial width of reel 25.

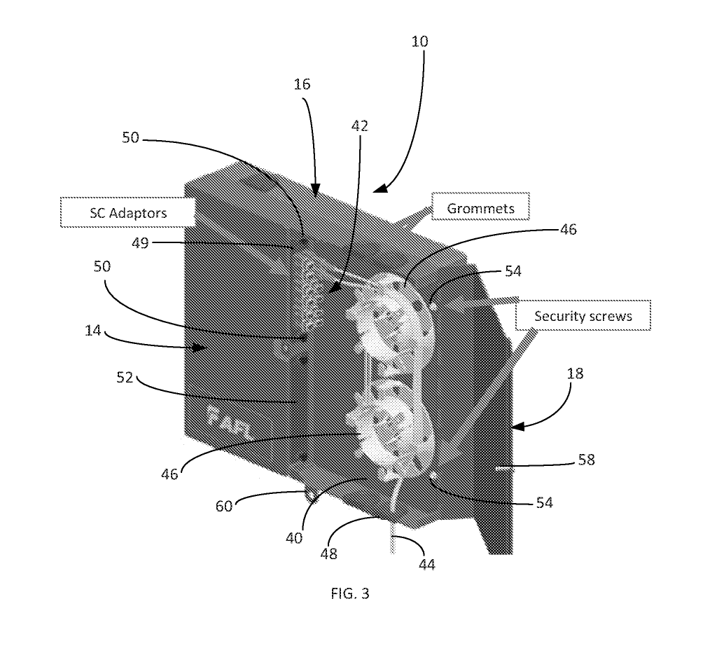

Referring now also to FIG. 3, lid 18 is shown in the open position to reveal the interior of the front compartment 40 defined in front housing 14. As can seen, individual subscriber adapters (collectively 42) of distribution module 32 are exposed to the interior of compartment 40. In the illustrated embodiment, the adapters are common SC adapters which allow connection of individual subscriber drop cables terminated with respective SC connecters, such as the two subscriber cables collectively indicated at 44. (Although twelve SC adaptors are shown in this example, one skilled in the art will appreciate that terminal assembly 12 can be configured for a variety of adaptor types and quantities.) Compartment 40 may contain one or more routing rings 46 for storing slack that would otherwise exist in the drop cables. In addition, compartment 40 may define top and bottom ports with respective grommets (such as the bottom port having grommet 48) for routing the drop cables outside of compartment 40. Preferably, lid 40 may have an L-shaped configuration as shown, allowing access to compartment 40 from both the front and the side when lid 40 is opened fully.

In this embodiment, module 32 is mounted with respect to enclosure 12 through the compartment 40. Specifically, module 32 includes a suitable flange 49 which is secured to front housing 14 via screws 50. Space is provided in the illustrated embodiment for a second module which is not used in this example. The space is thus covered by a removable plate (or “blank”) 52.

As can be seen inn FIGS. 2 and 3, front housing 14 is secured to rear housing 16 in this case by one or more fasteners (e.g., screws 54) that extend from compartment 40 into corresponding holes 56 in rear housing 16. In this way, the fasteners will be inaccessible when lid 18 is closed. Referring now to FIG. 1, lid 18 can itself be secured via a screw 58 (or other suitable fastener) and locked by a suitable locking mechanism. Screws 54 and 58 may be hex-head screws in this example, although screws for use with other drivers (e.g., Phillips, torx) are also contemplated. In this case, for example, front housing 14 and lid 18 include depending tabs 60 and 62 that come together when the lid is closed define a pad lock hole 64 (see FIGS. 1 and 3).

It can this be seen that the present invention provides a novel wall-mountable optical fiber distribution terminal assembly. Embodiments of the invention allow use of common connectors and cable to reduce costs. The in-board reel is preferably stored and protected during shipping and installation. Slack cable is then stored once deployed and reel is locked in position to prevent any further cable deployment. In addition, a stepped front housing secures the reel(s) and prevents unwanted access to the distribution module(s).

While preferred embodiments of the invention have been shown and described, modifications and variations may be made thereto by those of ordinary skill in the art without departing from the spirit and scope of the present invention. Furthermore, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. An optical fiber distribution terminal assembly comprising:
a housing having a first housing portion and a second housing portion moveable between an open position and a closed position defining an interior, said housing defining at least one port for passage of an optical fiber distribution cable;
a reel located in said interior of said housing, said reel carrying a length of said optical fiber distribution cable; and
a distribution module located in said housing, said distribution module operative to distribute service from said optical fiber distribution cable to individual subscriber cables.

2. An optical fiber distribution terminal assembly as set forth in claim 1, wherein said reel is configured to be maintained in a particular angular position when said second housing portion is in said closed position.

3. An optical fiber distribution terminal assembly as set forth in claim 2, wherein said reel has a series of positioning slots spaced apart about its periphery.

4. An optical fiber distribution terminal assembly as set forth in claim 3, wherein said second housing portion carries a protrusion that engages one of said positioning slots when said second housing portion is in the closed position.

5. An optical fiber distribution terminal assembly as set forth in claim 1, wherein one end of said optical fiber distribution cable is terminated with at least one fiber optic connector for receipt in a corresponding socket of said distribution module.

6. An optical fiber distribution terminal assembly as set forth in claim 5, wherein said distribution module further includes a plurality of individual subscriber sockets.

7. An optical fiber distribution terminal assembly as set forth in claim 6, wherein said second housing portion further defines a front compartment closable by a lid, said individual subscriber sockets being accessible by opening said lid.

8. An optical fiber distribution terminal as set forth in claim 7, wherein said second housing portion is secured to said first housing portion by fasteners accessible by opening said lid.

9. An optical fiber distribution terminal as set forth in claim 8, wherein lid is configured to be locked when closed.

10. An optical fiber distribution terminal as set forth in claim 1, wherein said second housing portion is connected to said first housing portion via at least one hinge.

11. An optical fiber distribution terminal as set forth in claim 10, wherein said at least one hinge comprises a lift off hinge.

12. An optical fiber distribution terminal assembly comprising:
a housing having a first housing portion and a second housing portion connectable together in a closed position so as to define an interior, said housing defining at least one port for passage of an optical fiber distribution cable;
a rotatable reel located in said interior of said housing, said reel carrying a length of said optical fiber distribution cable; and
wherein said reel is configured to be maintained in a particular angular position when said second housing portion is in said closed position.

13. An optical fiber distribution terminal assembly as set forth in claim 12, wherein said reel has a series of positioning slots spaced apart about its periphery.

14. An optical fiber distribution terminal assembly as set forth in claim 13, wherein said second housing portion carries a protrusion that engages one of said positioning slots when said housing is in the closed position.

15. An optical fiber distribution terminal assembly as set forth in claim 12, further comprising:
a distribution module located in said housing, said distribution module operative to distribute service from said optical fiber distribution cable to individual subscriber cables; and
wherein one end of said optical fiber distribution cable is terminated with at least one fiber optic connector for receipt in a corresponding socket of said distribution module.

16. An optical fiber distribution terminal assembly as set forth in claim 15, wherein said second housing portion further defines a front compartment closable by a lid, said distribution module extending between said front compartment and said interior of said housing.

17. An optical fiber distribution terminal as set forth in claim 16, wherein said second housing portion is secured to said first housing portion by fasteners accessible by opening said lid.

18. An optical fiber distribution terminal as set forth in claim 12, wherein said second housing portion is connected to said first housing portion via at least one hinge.

19. An optical fiber distribution terminal as set forth in claim 18, wherein said at least one hinge comprises a lift off hinge.

20. A combination comprising:
a reel having a hub and a pair of side flanges;
a length of fiber optic cable wrapped around said hub of the reel, said fiber optic cable having a first end and a second end;
said hub of said reel defining an aperture through which said first end of said fiber optic cable passes; and
said reel having a series of positioning slots spaced apart about a periphery of at least one of said flanges.

21. A combination as set forth in claim 20, wherein said reel has said positioning slots spaced apart about both of said flanges, said positioning slots on respective of said pair of flanges being aligned with each other.
